(19) United States
(12) Patent Application Publication
(10) Pub. No.: US 2020/0153999 A1
(43) Pub. Date: May 14, 2020

(54) IMAGE INSPECTION APPARATUS, IMAGE INSPECTION METHOD, AND IMAGE INSPECTION PROGRAM

(71) Applicant: KONICA MINOLTA, INC., Tokyo (JP)

(72) Inventors: Jun ITOU, Tokyo (JP); Makoto IKEDA, Tokyo (JP)

(73) Assignee: KONICA MINOLTA, INC., Tokyo (JP)

(21) Appl. No.: 16/601,674

(22) Filed: Oct. 15, 2019

(30) Foreign Application Priority Data
Nov. 12, 2018 (JP) 2018-211887

(51) Int. Cl. H04N 1/60; G06F 3/12; G03G 15/00; H04N 1/00

(52) U.S. Cl. CPC H04N 1/6008; H04N 1/00023; G03G 15/5041; G06F 3/1208

(57) ABSTRACT

An image inspection apparatus includes: an image reader that reads an original image on a recording material based on a print job and generates a read image; and a hardware processor that analyzes the read image acquired from the image reader and performs image inspection, in which the hardware processor: performs predetermined filter processing on the read image and generates a first reference image; acquires background density from the first reference image and sets a threshold based on the background density; compares the read image to the first reference image and generates a first comparison image; and binarizes the first comparison image by using the threshold, detects a part where a specific abnormality has occurred, and outputs a detection result.

The entire disclosure of Japanese patent Application No. 2018-211887, filed on Nov. 12, 2018, is incorporated herein by reference in its entirety.

### BACKGROUND

### Technological Field

The present invention relates to an image inspection apparatus, an image inspection method, and an image inspection program, and more particularly to an image inspection apparatus, an image inspection method, and an image inspection program for inspecting a read image.

### Description of the Related Art

In electrophotographic primed matter, an abnormality that is not contained in an image to be printed may occur. For example, a spotted abnormality caused by a so-called firefly phenomenon may occur at the time of transfer in electrophotography. The spotted abnormality appears in the form of light unevenness on a halftone image. The abnormality caused by a firefly phenomenon occurs when developer is filled with a high filling density. In such a case, the developer is compressed and solidified in space of a container body, and the solidified object of the developer is attached to paper.

There are many known methods for optically inspecting such an abnormality beyond the field of printing. For example, JP 2001-209798 A discloses, as a method of inspecting appearance of a semiconductor wafer, a method of optically inspecting a defect of an object having a repetitive pattern region, the method including generating a reference image by excluding shading change caused by a defect from a captured image of the repetitive pattern region; obtaining an image obtained by extracting only sharp shading-change amount by comparison operation between the reference image and the captured image; and determining presence or absence of a defective part by binarizing a luminosity value of the extracted image.

In the method of JP 2001-209798 A, a frequency component of a defective part desired to be detected from a captured image is excluded by performing smoothing processing to generate a reference image. Unfortunately, in the case of printed matter, an image to be printed contains various forms of content. For example, in the case where the image to be printed contains content having a frequency component equivalent to that of an abnormality desired to be detected, detection of a defective part using a method of JP 2001-209798 A results in erroneous detection of content that is not an abnormality.

### SUMMARY

The invention has been made in view of the above-described problems, and a main object thereof is to provide an image inspection apparatus, an image inspection method, and an image inspection program capable of appropriately detecting a specific abnormality from a read image.

To achieve the abovementioned object, according to an aspect of the present invention, an image inspection apparatus reflecting one aspect of the present invention comprises: an image reader that reads an original image on a recording material based on a print job and generates a read image; and a hardware processor that analyzes the read image acquired from the image reader and performs image inspection, wherein the hardware processor performs predetermined filter processing on the read image and generates a first reference image; acquires background density from the first reference image and sets a threshold based on the background density; compares the read image to the first reference image and generates a first comparison image; and binarizes the first comparison image by using the threshold, detects a part where a specific abnormality has occurred, and outputs a detection result.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic diagram illustrating an image inspection method according to one embodiment of the invention;

FIG. 2 is a schematic diagram illustrating a configuration example of an image inspection system according to a first embodiment of the invention;

FIG. 3 is a schematic diagram illustrating another configuration example of an image inspection system according to the first embodiment of the invention;

FIGS. 4A and 4B are block diagrams illustrating the configuration of an image inspection apparatus according to the first embodiment of the invention;

FIG. 5 is a flowchart illustrating operation of the image inspection apparatus according to the first embodiment of the invention;

FIG. 6 is a flowchart illustrating operation (abnormal part detection processing) of the image inspection apparatus according to the first embodiment of the invention;

FIG. 7 is a schematic diagram illustrating an image inspection method according to the first embodiment of the invention;

FIG. 8 illustrates a measurement result indicating the relation between background density and a firefly phenomenon according to the first embodiment of the invention;

FIG. 9 is a schematic diagram illustrating effects of a threshold in the image inspection method according to the first embodiment of the invention;

FIG. 10 is a schematic diagram illustrating the effects of a threshold in the image inspection method according to the first embodiment of the invention;

FIG. 11 illustrates a measurement result indicating the relation between background density and a firefly phenomenon according to a second embodiment of the invention; and

FIG. 12 illustrates a measurement result indicating the relation between background density and a firefly phenomenon according to the second embodiment of the invention.

### DETAILED DESCRIPTION OF EMBODIMENTS

Hereinafter, one or more embodiments of the present invention will be described with reference to the drawings. However, the scope of the invention is not limited to the disclosed embodiments.

As illustrated in the related art, a spotted abnormality caused by a firefly phenomenon may occur at the time of transfer in electrophotography. The spotted abnormality appears in the form of light unevenness on a halftone image. As a method of optically inspecting such an image abnormality, JP 2001-209798 A discloses a method of generating a reference image by processing of smoothing a captured image for inspecting the appearance of a semiconductor wafer. Unfortunately, in the case of printed matter, an image to be printed contains various forms of content, and, in the case where the image to be printed contains content having a frequency component equivalent to that of an abnormality desired to be detected, content that is not an abnormality is erroneously detected.

In one embodiment of the invention, in order to appropriately detect a specific abnormality such as an abnormality caused by a firefly phenomenon without erroneously detecting content in an image (called an original image) to be printed, a first reference image is generated by performing predetermined filter processing on a read image (or read image after exclusion processing in which an edge having a relatively high contrast is detected from a read image and a region in the vicinity of the edge is excluded from image inspection), background density is acquired from the first reference image, a threshold is set based on the background density, a first comparison image is generated by comparing the read image (or read image after the exclusion processing) to the first reference image, and the first comparison image is binarized by using the set threshold. Thus, a part where the specific abnormality has occurred is detected.

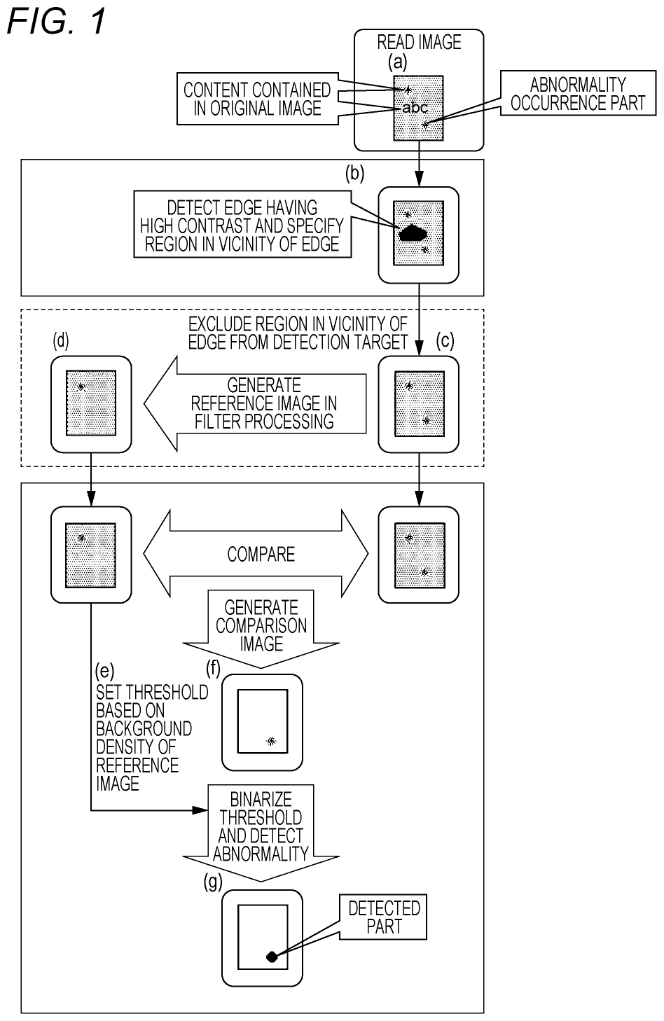

Specifically, as illustrated in FIG. 1, in the case where a read image contains content contained in an original image and an abnormality occurrence part (see (a) in FIG. 1), an edge having a relatively high contrast is detected from the read image as necessary by using a known approach (e.g., approach of defining as an edge, the position where the absolute value of primarily differentiated density change is maximized or the position where secondarily differentiated density change crosses zero), a region in the vicinity of the edge is specified (see (b) in FIG. 1), and the specified region in the vicinity of the edge is excluded from detection. An image is thus generated (see (c) in FIG. 1). Predetermined filter processing (e.g., a blurring processing) is performed on the read image (read image after the exclusion processing in FIG. 1) to generate a reference image (see (d) in FIG. 1). Background density is acquired from the reference image, and a threshold is set based on the background density (see (e) in FIG. 1). A threshold of a region having a relatively low background density is set higher than a threshold of a region having a relatively high background density (detection sensitivity is lowered). A comparison image is generated (see (f) in FIG. 1) by comparing (extracting the difference) the read image (read image after the exclusion processing in FIG. 1) to the reference image. The comparison image is binarized by using the threshold set in (e) in FIG. 1. An abnormal part is then detected (see (g) in FIG. 1).

In this way, erroneous detection of content such as text and graphics in an original image can be prevented by excluding a region in the vicinity of an edge having a relatively high contrast from abnormal part detection as necessary. A comparison image can contain an abnormality caused by a firefly phenomenon by performing blurring processing serving as filter processing, and a specific abnormality can be reliably detected. Both erroneous detection of noise at an acceptable level in a low-density region and detection omission of a specific abnormality in a high-density region can be inhibited by setting a threshold set based on a background density acquired from a reference image (setting a threshold of a region having a relatively low background density higher than a threshold of a region having a relatively high background density), and a specific abnormality can be reliably detected.

### First Embodiment

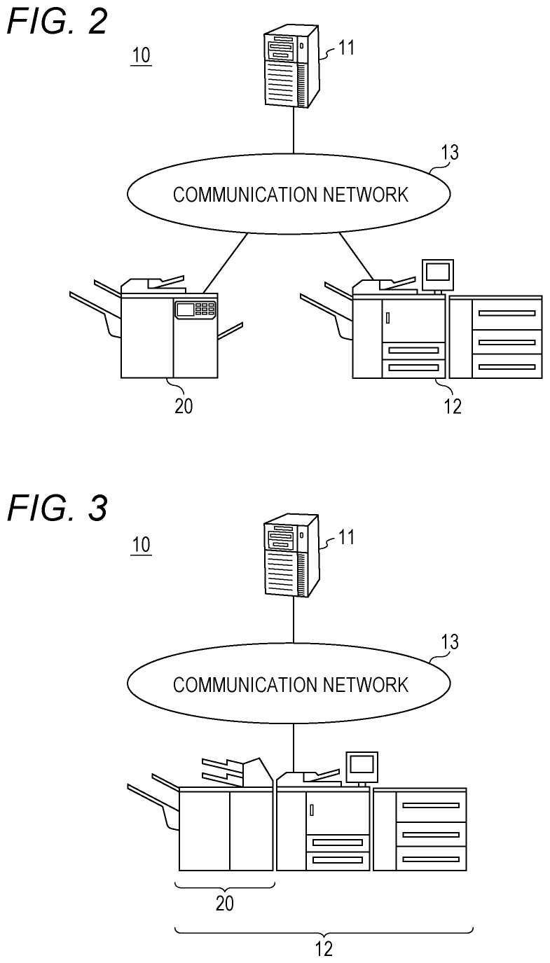

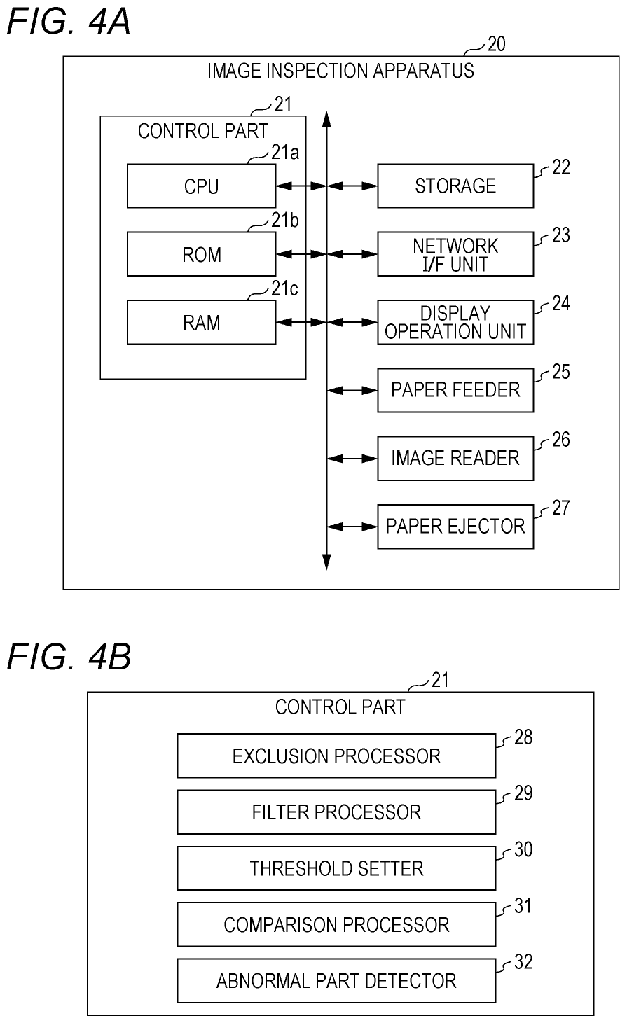

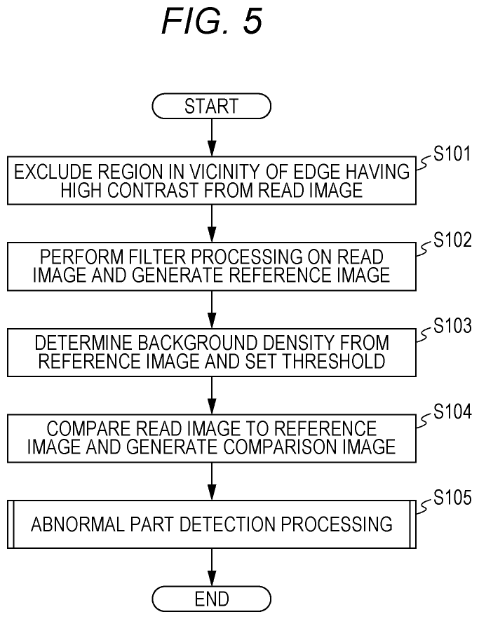

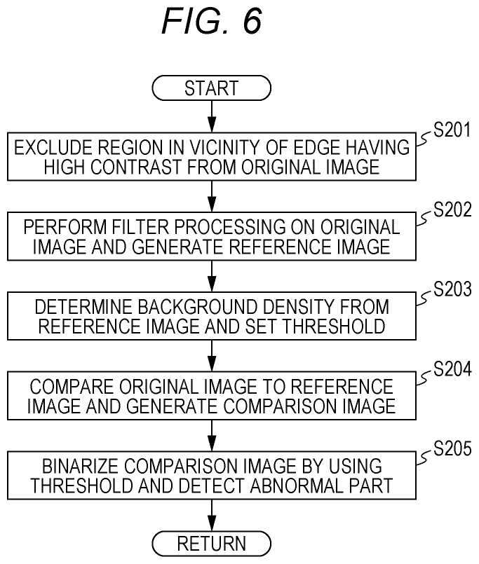

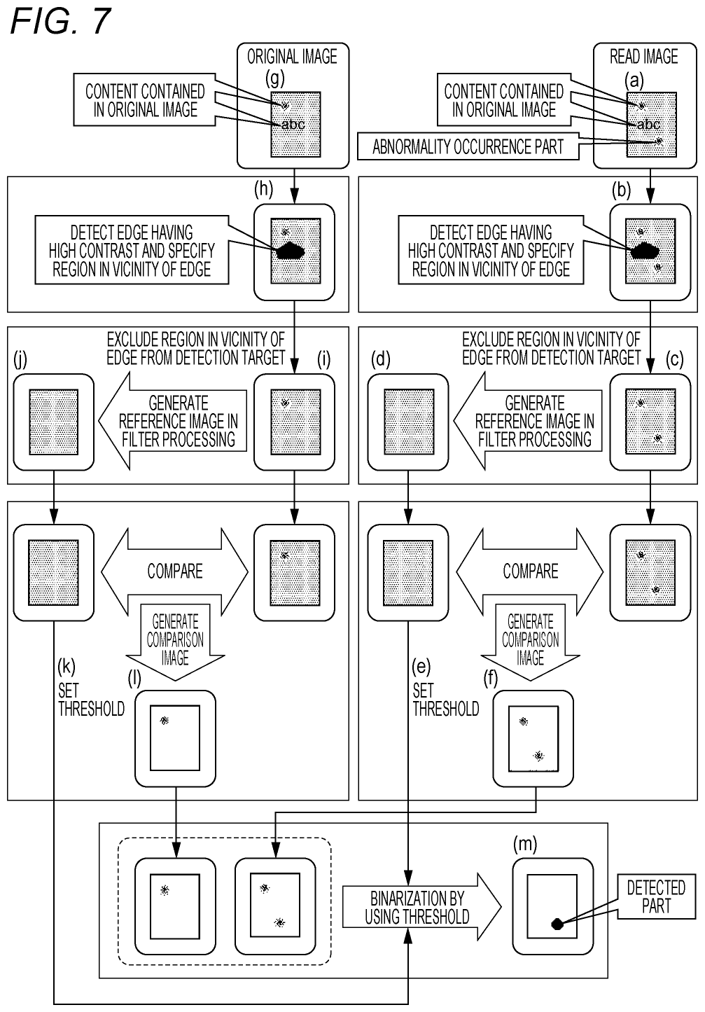

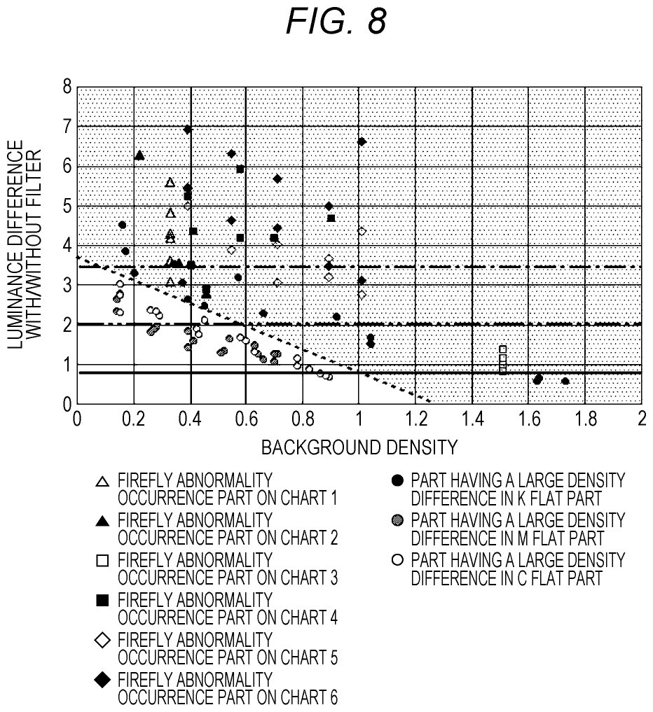

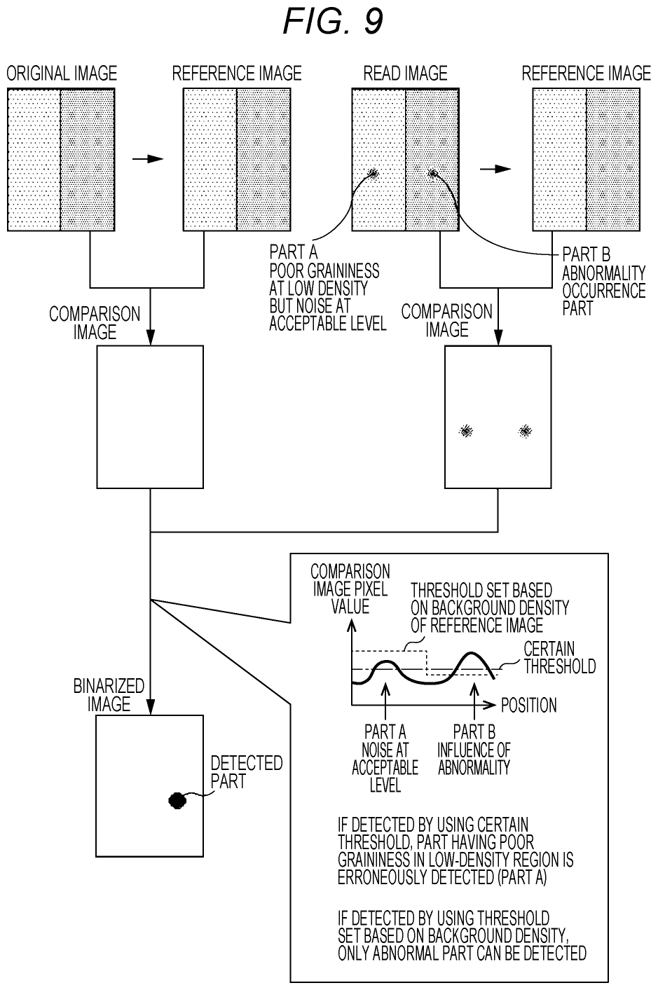

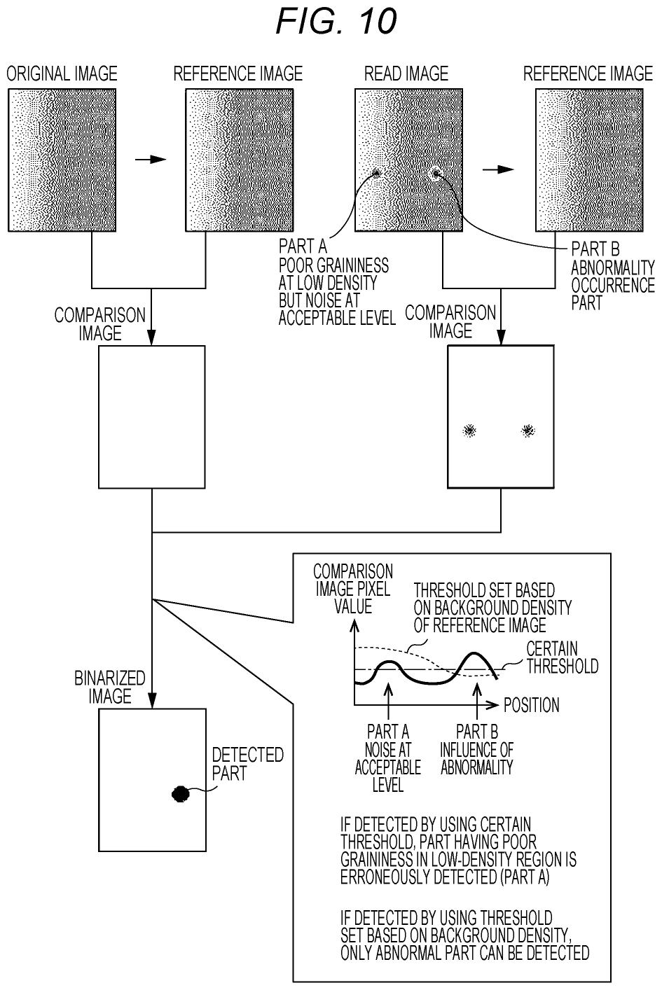

In order to describe the above-described one embodiment of the invention in more detail, an image inspection apparatus, an image inspection method, and an image inspection program according to a first embodiment of the invention will be described with reference to FIGS. 2 to 10. FIGS. 2 and 3 are schematic diagrams illustrating a configuration example of an image inspection system of the embodiment. FIGS. 4A and 4B are block diagrams illustrating the configuration of the image inspection apparatus of the embodiment. FIGS. 5 and 6 are flowcharts illustrating operations of the image inspection apparatus of the embodiment. FIG. 7 is a schematic diagram illustrating the image inspection method of the embodiment. FIG. 8 illustrates a measurement result indicating the relation between background density and a firefly phenomenon. FIGS. 9 and 10 are schematic diagrams illustrating effects of a threshold in the image inspection method of the embodiment.

As illustrated in FIG. 2, an image inspection system 10 of the embodiment includes a controller 11, an image forming apparatus 12, and an image inspection apparatus 20. The controller 11 includes a raster image processing (RIP) unit. The RIP unit performs RIP on a print job input from a computer apparatus (not illustrated), and outputs an image data (called original image data) after performing the RIP. The image forming apparatus 12 includes a printer that forms an image (original image) on recording material (paper) based on the original image data. The image inspection apparatus 20 reads the original image on the recording material, and inspects finished printed matter. These components are connected so as to communicate data via a communication network 13. The communication network 13 includes local area network (LAN) and wide area network (WAN), which are defined by standards such as Ethernet (registered trademark), a token ring, and a fiber-distributed data interface (FDDI).

The RIP unit of the above-described controller 11 translates a print job, which is written in a page description language (PDL) such as printer control language (PCL) and post script (PS), to generate intermediate data. The RIP unit performs color conversion on the intermediate data with a color conversion table, performs rendering, and generates image data of each page.

The printer of the above-described image forming apparatus 12 includes a component necessary for image formation using an image forming process such as an electrophotography, and prints an image based on the image data on designated paper. Specifically, the following pieces of processing are performed. An exposure device applies light in accordance with an image on a photoreceptor drum charged by a charging device to form an electrostatic latent image. A developing device develops the electrostatic latent image by attaching charged toner. The toner image is primarily transferred to a transfer belt, and secondarily transferred from the transfer belt to paper. A fixing device then fixes the toner image on the paper.

Although the image inspection system 10 includes the controller 11, the image forming apparatus 12, and the image inspection apparatus 20 in FIG. 2, the image inspection system 10 can be configured by the controller 11 and the image forming apparatus 12 as illustrated in FIG. 3 in the case where the image forming apparatus 12 has a function of the image inspection apparatus 20. In the case where the image forming apparatus 12 has a function of the controller 11 (the image forming apparatus 12 includes the RIP unit), the image inspection system 10 can be configured by the image forming apparatus 12 and the image inspection apparatus 20 (or only the image inspection apparatus 20). The image inspection apparatus 20 will be described below on the premise of the configuration in FIG. 2.

As illustrated in FIG. 4A, the image inspection apparatus 20 having the configuration in FIG. 2 includes a controller 21, a storage 22, a network I/F unit 23, a display operation unit 24, a paper feeder 25, an image reader 26, and a paper ejector 27.

The controller 21 includes a central processing unit (CPU) 21a and a memory such as a read only memory (ROM) 21b and a random access memory (RAM) 21c. These components are connected via a bus. The CPU 21a controls the entire image inspection apparatus 20 by reading a program from the ROM 21b and the storage 22 and decompressing and executing the program in the RAM 21c. In particular, in the embodiment, an image is inspected by analyzing a read image acquired from the image reader 26.

The storage 22 includes a hard disk drive (HDD) and a solid state drive (SSD). The storage 22 stores a program for the CPU 21a to control each unit, original image data, read image data obtained by reading an original image on paper, and a later-described threshold.

The network I/F unit 23 includes a network interface card (NIC) and a modem. The network I/F unit 23 connects the image inspection apparatus 20 to the communication network 13, and enables the image inspection apparatus 20 to receive the original image data from the controller 11.

The display operation unit 24 includes a touch panel with an operation unit on a display. The operation unit includes a touch sensor with electrodes arranged in a lattice shape. The display includes a liquid crystal display (LCD) and an organic electro luminescence (EL) display. The display operation unit 24 displays various screens related to operations of the image inspection apparatus 20, and receives various operations related to the operations of the image inspection apparatus 20. The display operation unit 24 may include a hard key serving as an operation unit. The display and the operation unit may be separate devices.

The paper feeder 25 includes one or a plurality of paper feeding trays. The paper feeder 25 conveys paper, on which an image (original image) is formed by the image forming apparatus 12, to the image reader 26.

The image reader 26 reads an image (original image) on paper. For example, the image reader 26 optically scans the paper on which an image is formed, forms an image of light reflected from the paper on a light receiving surface of a sensor such as a charge coupled device (CCD), reads the image, and generates a read image.

The paper ejector 27 includes one or a plurality of paper ejecting trays. The paper ejector 27 ejects paper after the image is read. In the embodiment, the paper ejector 27 preferably includes a plurality of paper ejecting trays, so that a later-described abnormal part detector 32 can eject paper, in which a specific abnormality (in the embodiment, an abnormality caused by a firefly phenomenon) has been detected, in distinction from normal paper.

As illustrated in FIG. 4B, the above-described controller 21 also functions as an exclusion processor 28, a filter processor 29, a threshold setter 30, a comparison processor 31, and an abnormal part detector 32.

The exclusion processor 28 is provided as necessary. The exclusion processor 28 detects an edge having a relatively high contrast from the read image generated by the image reader 26, and excludes a region in the vicinity of the edge (region surrounding a series of edges) from image inspection (abnormal part detection). The exclusion processor 28 thereby prevents content such as text and graphics in the original image from being erroneously detected as an abnormal part. The exclusion processor 28 acquires an original image from, for example, the controller 11 and the image forming apparatus 12, detects an edge having a relatively high contrast from the original image, and excludes a region in the vicinity of the edge from abnormal part detection. In the case where the original image contains content having a frequency component equivalent to a specific abnormality (e.g., an abnormality caused by a firefly phenomenon), the exclusion processor 28 excludes the content from abnormality detection. The exclusion includes both deletion and setting. In the former case, a region in the vicinity of an edge or content is deleted from a read image or an original image (in a case where an image has a uniform ground, the region in the vicinity of the edge or the content is overwritten by a ground image). In the latter case, setting is performed not to detect an abnormal part in the region in the vicinity of the edge or the content without deleting the region in the vicinity of the edge or the content from the read image or the original image (or without performing overwriting with the ground image).

The filter processor 29 performs filter processing (blurring processing, e.g., processing of averaging pixel values of pixels of interest by using the pixel value of the surrounding pixels) of filtering a specific abnormality (e.g., an abnormality caused by a firefly phenomenon) on a read image generated by the image reader 26 or a read image after exclusion processing performed by the exclusion processor 28. The filter processor 29 generates a reference image (first reference image). The filter processor 29 performs filter processing similar to that for the read image on an original image acquired from the controller 11 or an original image after the exclusion processing performed by the exclusion processor 28. The filter processor 29 generates a reference image (second reference image).

The threshold setter 30 acquires background density from the first reference image (or the original image or the second reference image), and sets a threshold based on the background density. Specifically, the threshold setter 30 divides the first reference image (or the original image or the second reference image) into regions of a predetermined size, averages densities of the regions, and determines the background density. For example, the threshold setter 30 converts resolution from 400 dots per inch (dpi) with 4×4 pixels to 100 dpi with 1×1 pixel, acquires densities of the pixels (in the case, pixels of 0.254 mm), and determines the background density. The threshold setter 30 sets a threshold of a region having a relatively low background density higher than a threshold of a region having a relatively high background density (lowers detection sensitivity). In a case where the exclusion processing and the filter processing are performed, the background density means the density of ground from which content and a specific abnormality are excluded. If a region is increased in size, the influence of density change caused by an edge having a relatively high contrast or a specific abnormality can be reduced to an extent. The background density can thus be acquired from the reference image (first or second reference image) on which only the filter processing is performed or an original image on which no filter processing is performed.

The comparison processor 31 compares the read image generated by the image reader 26 or the read image after the exclusion processing performed by the exclusion processor 28 to the reference image (first reference image), extracts difference, and generates a comparison image (first comparison image) obtained by the difference. The comparison processor 31 compares the original image acquired from the controller 11 or the original image after the exclusion processing performed by the exclusion processor 28 to the reference image (second reference image), extracts difference, and generates a comparison image (second comparison image) obtained by the difference.

The abnormal part detector 32 binarizes the first comparison image by using the threshold set by the threshold setter 30 (or binarizes the first and second comparison images by using the threshold set by the threshold setter 30, and extracts the difference between the binarized images), detects a part where a specific abnormality (e.g., an abnormality caused by a firefly phenomenon) has occurred, and outputs a detection result. For example, the abnormal part detector 32 displays the detection result on the display operation unit 24, and outputs paper in which a specific abnormality is detected to a paper ejecting tray different from a paper ejecting tray to which abnormal paper is ejected.

The above-described exclusion processor 28, filter processor 29, threshold setter 30, comparison processor 31, and abnormal part detector 32 may be configured in hardware. An image inspection program may be configured to cause the controller 21 to function as the exclusion processor 28, the filter processor 29, the threshold setter 30, the comparison processor 31, and the abnormal part detector 32 (in particular, the filter processor 29, the threshold setter 30, the comparison processor 31, and the abnormal part detector 32). The CPU 21a may execute the image inspection program.

FIGS. 4A and 4B illustrates one example of the image inspection apparatus 20 of the embodiment, and the configuration can be changed as appropriate. For example, the image inspection system 10 having the configuration in FIG. 3 can read an image on paper with an inline sensor of the image forming apparatus 12. In the case, components such as the paper feeder 25, the image reader 26, and the paper ejector 27 can be omitted.

Specific operation of the image inspection apparatus 20 of the embodiment will be described below with reference to FIGS. 5 to 10. The CPU 21a executes the processing of each step illustrated in the flowcharts of FIGS. 5 and 6 by decompressing and executing, on the RAM 21c, an image inspection program stored in the ROM 21b or the storage 22. In the following description, as illustrated in FIG. 7, an original image is a uniform halftone image (represented by dotted hatching in the figure). The image contains one piece of spotted content and one piece of text content (see (g) in FIG. 7). A spotted abnormality has occurred at one part of a read image obtained by reading the original image (see (a) in FIG. 7).

The controller 21 (exclusion processor 28) acquires a read image generated by the image reader 26 as necessary, detects an edge having a relatively high contrast from the read image, specifies a region in the vicinity of the edge, and excludes the specified region in the vicinity of the edge from abnormal part detection (S101). For example, as illustrated in (b) in FIG. 7, the controller 21 (exclusion processor 28) specifies a text region by detecting a character printed in a color (e.g., black) having high contrast to a ground color. As illustrated in (c) in FIG. 7, the controller 21 (exclusion processor 28) deletes the specified region from the read image. Since the gradations sharply change in the vicinity of the edge, erroneous detection may occur in detecting an abnormal part. The erroneous detection can be prevented by detecting an edge portion and excluding the vicinity of the edge from abnormal part detection. A method using a differential filter represented Sobel filter is generally known for detecting the edge portion. The position where the absolute value of primarily differentiated density change is maximized or the position where secondarily differentiated density change crosses zero can be detected as an edge.

The controller 21 (filter processor 29) performs predetermined filter processing on the read image generated by the image reader 26 or the read image after the exclusion processing to generate the reference image (first reference image)(S102, see (d) in FIG. 7). This filter is used for removing frequency of an abnormality desired to be detected. The strength and size of the filter depend on the abnormality desired to be detected. For example, the firefly phenomenon often occurs as a phenomenon of a diameter of approximately 1 to 3 mm. Setting the filter size to, for example, approximately 5 mm can generate a reference image in which the influence of the firefly phenomenon has been removed.

The controller 21 (threshold setter 30) acquires background density from the reference image, and sets a threshold based on the background density (S103, see (e) in FIG. 7). For example, the controller 21 (threshold setter 30) divides the reference image into regions of a predetermined size, averages densities of the regions, determines the background density, and sets a threshold for each region based on background images of the regions.

The controller 21 (comparison processor 31) compares the read image generated by the image reader 26 or the read image after the exclusion processing to the reference image (first reference image) to generate a comparison image (first comparison image) (S104, see (f) in FIG. 7). For example, the controller 21 (comparison processor 31) calculates the difference between pixel values at corresponding positions of two images to generate the comparison image. The difference value occurs only at a part where a difference is exhibited between the two images at the time of calculating the difference, that is, a part where a spotted abnormality has originally occurred.

The controller 21 (abnormal part detector 32) processes (binarizes) the comparison image by using the threshold set in S103, detects an abnormal part, and outputs a detection result (S105, see (m) in FIG. 7). The difference value occurs at a part where a spotted abnormality has occurred in the comparison image, and thus the part where the abnormality has occurred can be detected in the processing.

Here, the original image often includes not only halftone but some content. For example, in the case where the original image has content having a frequency component equivalent to an abnormality desired to be detected, abnormal part detection using only a read image causes erroneous detection of a content part where no abnormality has occurred. In the embodiment, processing similar to that performed on a read image is performed on an original image. A comparison image (second comparison image) is generated from the original image. An abnormal part is detected by using both a comparison image (first comparison image) generated from the read image and a comparison image (second comparison image) generated from the original image.

FIG. 6 illustrates a specific example of the abnormal part detection processing of S105 in FIG. 5 in the case of using the original image.

The controller 21 (exclusion processor 28) first acquires an original image from, for example, the controller 11 and the image forming apparatus 12 as necessary, detects an edge having a relatively high contrast from the original image, specifies a region in the vicinity of the edge, and excludes the specified region in the vicinity of the edge from abnormal part detection (S201, see (g) to (i) in FIG. 7).

The controller 21 (filter processor 29) performs the above-described predetermined filter processing on the original image acquired from, for example, the controller 11 and the image forming apparatus 12 or the original image after the exclusion processing to generate the reference image (second reference image)(S202, see (j) in FIG. 7).

The controller 21 (threshold setter 30) acquires background density from the reference image, and sets a threshold based on the background density (S203, see (k) in FIG. 7). For example, the controller 21 (threshold setter 30) divides the reference image into regions of a predetermined size, averages densities of the regions, determines the background density, and sets a threshold for each region based on background images of the regions.

The controller 21 (comparison processor 31) compares the original image acquired from, for example, the controller 11 and the image forming apparatus 12 or the original image after the exclusion processing to the reference image to generate the comparison image (second comparison image) (S204, see (1) in FIG. 7). In the comparison image, the difference value occurs only at a part, in the original image, of content having a frequency component equivalent to that of a spotted abnormality.

The controller 21 (abnormal part detector 32) processes (binarizes) the comparison image by using the threshold set in S203, detects an abnormal part by extracting the difference between the binarized first and second comparison images, and outputs a detection result (S205, see (m) in FIG. 7).

In the above-described flow, the threshold set based on the background density of the reference image (first reference image) generated from the read image is applied to the comparison image (first comparison image) generated from the read image, and the threshold set based on the background density of the reference image (second reference image) generated from the original image is applied to the comparison image (second comparison image) generated from the original image. The background densities, however, do not significantly change between the read image and the original image. A threshold set based on the background density of one of the reference images (preferably, second reference image generated from the original image) may be applied to both the comparison images, and a threshold set based on the background density of the original image may be applied to both the comparison images.

Although, in the above-described flow, the comparison image is generated after setting a threshold, the threshold may be set after generating the comparison image. Although, in the above-described flow, threshold setting, comparison image generation, and abnormal part detection are sequentially performed for each image, the threshold setting, comparison image generation, and abnormal part detection may be repeated for each region of a predetermined size.

How to set the threshold based on the background density will now be described. FIG. 8 illustrates the relation between background density and a firefly phenomenon. FIG. 8 illustrates a result of abnormal part detection performed by preliminarily printing, for example, a test pattern (called gradation pattern) in which the background density is gradually changed. FIG. 8 illustrates a part, on various pieces of paper (charts 1 to 6), where an abnormality (here, abbreviated as a firefly abnormality) caused by a firefly phenomenon has occurred. FIG. 8 also illustrates the relation between the background density at a part having maximum density difference among parts, where K/M/C is flat (toner thickness is uniform) with no firefly abnormality and luminance difference (corresponding to density difference in the comparison image) before and after filter processing.

As illustrated in FIG. 8, the region having a low background density has large luminance difference before and after the filter processing at a firefly abnormality occurrence part, and also has large luminance difference before and after the filter processing at a flat part having a large density difference. The region having a high background density has small luminance difference before and after the filter processing at a flat part having a large density difference, and also has small luminance difference before and after the filter processing at a firefly abnormality occurrence part. For this reason, if a threshold is set low at a certain level (see the two-dot dashed line in FIG. 8), erroneous detection occurs at a flat part (in particular, part where M/C is flat) having a large density difference. If the threshold is set high at a certain level (see the dot dashed line in FIG. 8), detection omission of the firefly abnormality occurs. The threshold is required to be set to enable reliable detection of a hatched region in FIG. 8. In the embodiment, the threshold of a region having a relatively low background density is set to be higher than the threshold of a region having a relatively high background density. The detection omission of the firefly abnormality can be inhibited while inhibiting erroneous detection of noise at an acceptable level.

The effect in the case where a threshold is set based on the background density as described above will be described with reference to FIGS. 9 and 10. FIGS. 9 and 10 illustrate how a detection result of an abnormal part changes between when a certain threshold is applied and when a threshold set based on a background density is applied.

FIG. 9 illustrates a case in which an original image is processed. The original image has a relatively low background density on the left and a relatively high background density on the right. Noise at an acceptable level is located at a part A in FIG. 9, and an abnormality has occurred at a part B. In the case, if the entire surface of a comparison image is binarized by using a certain threshold (see the dot dashed line in the balloon in FIG. 9), the part A is also detected in addition to the part B since pixel values of the parts A and B exceed the threshold. Unfortunately, the part A is noise (density difference variation) of a level that cannot be said as an abnormality, and as a result, erroneous detection occurs.

This type of erroneous detection occurs since, in a background region of low density, poor graininess (e.g., large RMS graininess) causes a rough and noisy image, and identification of whether a part is noise at an acceptable level or an abnormality is difficult. In a background region of a high density, an abnormality, such as the part B, caused by a firefly phenomenon of light density variation is easily identified. If a threshold is raised to inhibit erroneous detection in a background region of a low density, detection omission of an abnormal part may occur.

In the embodiment, the threshold is set for each region based on the background density of a reference image (see the broken line in the balloon in FIG. 9). For example, the background density is low on the left of paper, and noise at an acceptable level is easily detected erroneously. Thus, the erroneous detection is inhibited by raising the threshold (i.e., lowering detection sensitivity) with reference to the measurement result in FIG. 8. In contrast, the background density is high on the right of the paper, and an abnormality is easily detected. Thus, detection omission of an abnormal part is inhibited by lowering the threshold (i.e., raising the detection sensitivity) with reference to the measurement result in FIG. 8.

Although FIG. 9 illustrates the case where the background density is constant on the left and right of the paper, the same applies to the case where the background density changes gradually or changes in a specific region. For example, as illustrated in FIG. 10, in the case where the background density gradually changes (here, the background density gradually increases from left to right of the paper), the threshold can be changed in accordance with changes of the background density (raised along with lowering background density) with reference to the measurement result in FIG. 8, as illustrated by the broken line in the balloon.

As described above, erroneous detection of content such as text and graphics in an original image can be prevented by excluding a region in the vicinity of an edge having a relatively high contrast from abnormal part detection as necessary. A comparison image can contain an abnormality caused by a firefly phenomenon by performing blurring processing serving as filter processing, and a specific abnormality can be reliably detected. Both erroneous detection in a low-density region and detection omission in a high-density region can be inhibited by using, as a threshold, a threshold set based on a background density acquired from a reference image or an original image, and a specific abnormality can be reliably detected.

### Second Embodiment

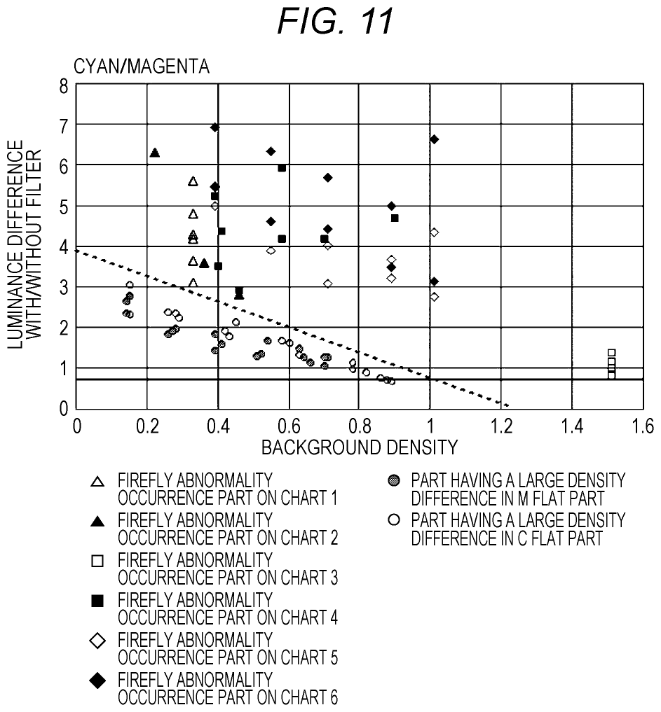

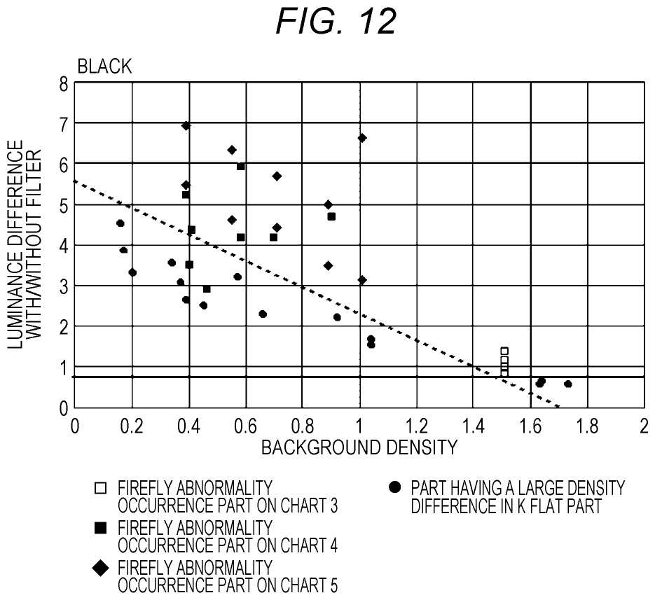

An image inspection apparatus, an image inspection method, and an image inspection program according to a second embodiment of the invention will now be described with reference to FIGS. 11 and 12. FIGS. 11 and 12 illustrate measurement results indicating the relation between background density and a firefly phenomenon.

Although, in the above-described first embodiment, the case where a threshold is set based on background density has been described, graininess is changed depending on background colors and paper types, and detection accuracy of an abnormality caused by a firefly phenomenon is also changed. The problem will be described with reference to the drawings.

FIG. 11 illustrates the relation between background density and a firefly phenomenon in the region of the background of Cyan/Magenta from the measurement results in FIG. 8. FIG. 12 illustrates the relation between background density and the firefly phenomenon in the region of the background of Black from the measurement results in FIG. 8.

As found from comparison between FIG. 11 and FIG. 12, compared to Cyan and Magenta, in, for example, Black and 3C (mixed color of CMY), deterioration in graininess at low density increases the possibility of erroneously detecting, as a firefly abnormality, a part (e.g., part having noise at an acceptable level) having maximum density difference in a flat part. In the embodiment, in the case where the original image is composed of CMYK data, erroneous detection of noise at an acceptable level is inhibited by changing the threshold in accordance with the proportion of K (raising the threshold as the proportion of K increases, for example, raising an offset or increasing an inclination).

The degree of graininess varies depending on paper types, and the visibility (luminance difference before and after filter processing) of a firefly abnormality changes. For example, as illustrated in FIG. 11, charts such as a chart 6 (see black rhombuses) have high visibility (large luminance difference) of a firefly abnormality. In contrast, charts such as a chart 4 (see black squares) and a chart 5 (see white rhombuses) have low visibility (small luminance difference) of a firefly abnormality, and thus erroneous detection of noise at an acceptable level or detection omission of the firefly abnormality are more likely to occur. In the embodiment, a firefly abnormality can be detected with high accuracy by preliminarily printing a test pattern (gradation pattern), whose background density is gradually changed, on recording materials of various paper type, detecting an abnormal part, and dynamically changing (adjusting an offset or inclination) a threshold in accordance with the paper type with reference to the measurement result. The same as the paper type is applied to basis weight. A firefly abnormality can be detected with high accuracy by preliminarily printing a test pattern on recording materials of various basis weights, detecting an abnormal part, and dynamically changing (adjusting an offset or inclination) a threshold in accordance with the basis weight with reference to the measurement result.

In the case, the configuration of the image inspection apparatus 20 is similar to that in the above-described first embodiment. The controller 21 (threshold setter 30) acquires the background density from the first reference image (or the original image or the second reference image). In the case where the original image is composed of CMYK data, the controller 21 (threshold setter 30) changes the threshold in accordance with the proportion of K (raises the threshold as the proportion of K increases) at the time of setting the threshold based on the background density. A test pattern (gradation pattern) is printed on a plurality of recording materials which have different paper types and basis weights, and an abnormal part is detected. The controller 21 (threshold setter 30) changes the threshold in accordance with the paper types and the basis weights with reference to the measurement result. At the time, the offset or inclination of the threshold may be set by using a preset value of a manufacturer for major paper types. Prior measurement can be omitted by using the preset value.

In this way, a specific abnormality can be reliably detected by changing a threshold (offset or inclination) in accordance with, for example, the proportion of K, a paper type, and a basis weight.

It should be noted that the invention is not limited to the description of each of the above-described embodiments, and the configuration and control can be appropriately changed without departing from the spirit of the invention.

For example, although, in each of the above-described embodiments, the abnormality caused by a firefly phenomenon is exemplified as a specific abnormality occurring in a read image, the image inspection method of the invention can be similarly applied to any abnormality in which density difference changes.

The invention can be used for an image inspection apparatus for inspecting a read image, an image inspection method in the image inspection apparatus, an image inspection program that operates in the image inspection apparatus, and a recording medium in which the image inspection program has been recorded.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image inspection apparatus comprising:
an image reader that reads an original image on a recording material based on a print job and generates a read image; and
a hardware processor that analyzes the read image acquired from the image reader and performs image inspection,
wherein the hardware processor:
performs predetermined filter processing on the read image and generates a first reference image;
acquires background density from the first reference image and sets a threshold based on the background density;
compares the read image to the first reference image and generates a first comparison image; and
binarizes the first comparison image by using the threshold, detects a part where a specific abnormality has occurred, and outputs a detection result.

2. The image inspection apparatus according to claim 1,
wherein the hardware processor:
detects an edge from the read image and excludes a region in a vicinity of the edge from the image inspection;
performs the predetermined filter processing on the read image after exclusion processing and generates the first reference image; and
compares the read image after exclusion processing to the first reference image and generates the first comparison image.

3. The image inspection apparatus according to claim 1,
wherein the hardware processor divides the first reference image into regions of a predetermined size, determines the background density by averaging densities of the regions, and sets the threshold for each of the regions based on the background density of each of the regions.

4. The image inspection apparatus according to claim 1,
wherein the hardware processor:
performs the predetermined filter processing on the original image and generates a second reference image;
acquires background density from the original image or the second reference image and sets a threshold based on the background density;
compares the original image to the second reference image and generates a second comparison image; and
binarizes the second comparison image or the first and second comparison images by using the threshold and detects a part where the specific abnormality has occurred.

5. The image inspection apparatus according to claim 4,
wherein the hardware processor:
detects an edge from the original image and excludes a region in a vicinity of the edge from the image inspection;
performs the predetermined filter processing on the original image after exclusion processing and generates the second reference image; and
compares the original image after exclusion processing to the second reference image and generates the second comparison image.

6. The image inspection apparatus according to claim 4,
wherein the hardware processor divides the original image or the second reference image into regions of a predetermined size, determines the background density by averaging densities of the regions, and sets the threshold for each of the regions based on the background density of each of the regions.

7. The image inspection apparatus according to claim 4,
wherein, in a case where the original image includes CMYK data, the hardware processor changes the threshold in accordance with a proportion of K.

8. The image inspection apparatus according to claim 3,
wherein the hardware processor generates a comparison image for each of the regions, and
detects the abnormal part for each of the regions.

9. The image inspection apparatus according to claim 1,
wherein the hardware processor sets the threshold with reference to a result obtained by reading a recording material on which a pattern whose background density is gradually changed is preliminarily printed.

10. The image inspection apparatus according to claim 1,
wherein the hardware processor changes the threshold in accordance with a paper type or basis weight of the recording material.

11. The image inspection apparatus according to claim 1,
wherein the hardware processor sets the threshold of a region having a relatively low background density higher than the threshold of a region having a relatively high background density.

12. The image inspection apparatus according to claim 1,
wherein the specific abnormality is based on a firefly phenomenon.

13. An image inspection method in an image inspection apparatus including: an image reader that reads an original image on a recording material based on a print job and generates a read image; and a hardware processor that analyzes the read image acquired from the image reader and performs image inspection, the image inspection method comprising:
filtering performed with predetermined filter processing on the read image and generating a first reference image;
acquiring background density from the first reference image and setting a threshold based on the background density;
comparing the read image to the first reference image and generating a first comparison image; and
binarizing the first comparison image by using the threshold, detecting a part where a specific abnormality has occurred, and outputting a detection result.

14. The image inspection method according to claim 13, further comprising detecting an edge from the read image and excluding a region in a vicinity of the edge from the image inspection,
wherein, in the filtering, the predetermined filter processing is performed on the read image after exclusion processing and the first reference image is generated, and
in the comparing, the read image after exclusion processing is compared to the first reference image and the first comparison image is generated.

15. The image inspection method according to claim 13,
wherein, in the threshold setting, the first reference image is divided into regions of a predetermined size, the background density is determined by averaging densities of the regions, and the threshold is set for each of the regions based on the background density of each of the regions.

16. The image inspection method according to claim 13,
wherein, in the filtering, the predetermined filter processing is performed on the original image, and a second reference image is generated,
in the threshold setting, background density is acquired from the original image or the second reference image and a threshold is set based on the background density,
in the comparing, the original image is compared to the second reference image and the second comparison image is generated, and
in the abnormal part detecting, the second comparison image or the first and second comparison images are binarized by using the threshold and a part where the specific abnormality has occurred is detected.

17. The image inspection method according to claim 16, further comprising
detecting an edge from the original image and excluding a region in a vicinity of the edge from the image inspection,
wherein, in the filtering, the predetermined filter processing is performed on the original image after exclusion processing and the second reference image is generated, and
in the comparing, the original image after exclusion processing is compared to the second reference image and the second comparison image is generated.

18. The image inspection method according to claim 16,
wherein, in the threshold setting, the original image or the second reference image is divided into regions of a predetermined size, the background density is determined by averaging densities of the regions, and the threshold is set for each of the regions based on the background density of each of the regions.

19. The image inspection method according to claim 16,
wherein, in the threshold setting, in a case where the original image includes CMYK data, the threshold is changed in accordance with a proportion of K.

20. The image inspection method according to claim 15,
wherein, in the comparing, a comparison image is generated for each of the regions, and
in the abnormal part detection processing, the abnormal part is detected for each of the regions.

21. The image inspection method according to claim 13,
wherein, in the threshold setting, the threshold is set with reference to a result obtained by reading a recording material on which a pattern whose background density is gradually changed is preliminarily printed.

22. The image inspection method according to claim 13,
wherein, in the threshold setting, the threshold is changed in accordance with a paper type or basis weight of the recording material.

23. The image inspection method according to claim 13,
wherein, in the threshold setting, the threshold of a region having a relatively low background density is set higher than the threshold of a region having a relatively high background density.

24. The image inspection method according to claim 13,
wherein the specific abnormality is based on a firefly phenomenon.

25. A non-transitory recording medium storing a computer readable image inspection program that operates in an image inspection apparatus including: an image reader that reads an original image on a recording material based on a print job and generates a read image; and a hardware processor that analyzes the read image acquired from the image reader and performs image inspection,
the image inspection program causing the hardware processor to execute:
performing predetermined filter processing on the read image and generating a first reference image;
acquiring background density from the first reference image and setting a threshold based on the background density;
comparing the read image to the first reference image and generating a first comparison image; and
binarizing the first comparison image by using the threshold, detecting a part where a specific abnormality has occurred, and outputting a detection result.
